(19) United States
(12) Patent Application Publication
(10) Pub. No.: US 2001/0023444 A1
(43) Pub. Date: Sep. 20, 2001

(54) Information processing apparatus, information processing method and information processing program for transmitting data to external apparatus for communication of information on device

(76) Inventor: Minoru Torii, Tokyo (JP)

Correspondence Address: FITZPATRICK CELLA HARPER & SCINTO, 30 ROCKEFELLER PLAZA, NEW YORK, NY, 10112, US

(21) Appl. No.: 09/789,642

(22) Filed: Feb. 22, 2001

(30) Foreign Application Priority Data
Feb. 23, 2000 (JP) 2000-045706
Mar. 28, 2000 (JP) 2000-089656

(51) Int. Cl. G06F 15/16

(52) U.S. Cl. 709/228

(57) ABSTRACT

The invention provides a network management system in which the server and the client switch the data transmission method of connection type and that of connectionless type according to the size of the transmitted data, thereby selectively using the packet of datagram type and that of data stream type, thus achieving high-speed data communication.

### BACKGROUND OF THE INVENTION

1. Field of the Invention

The present invention relates to an information processing apparatus for use in a network management system for executing data transfer for communicating information on a device based on a network management software, an information processing method and an information processing program to be executed in the information processing apparatus.

2. Related Background Art

For managing a network, there has conventionally been known a method utilizing SNMP (simple network monitoring protocol)/MIB (management information base) (details of SNMP/MIP being described in “Guide to TCP/IP network management: For practical management” (M. T. Rose; translated by Takeshi Nishida; published by Toppan Co., first edition Aug. 20, 1992).

According to the SNMP network management technology, a network management system includes at least a network management station (NMS), a certain number of management object nodes each containing an agent (agent software), and a network management protocol to be used by the management station and the agent for exchanging the management information. The user can acquire the data of a management object node and can change data such as set data thereof, by communicating with the agent software of the management object node, utilizing a network management software (network management program) on the NMS.

The above-described network management software, when used in a dispersed environment, usually has a configuration consisting of a server application having the SNMP network management function and plural client applications each constituting a GUI (graphical user interface for man-computer interfacing through icons or the like) activated in each terminal.

As a standard for interprocess communication of the client application and the server application between the different terminals, there is defined RFC (request for comments) 1057 RRPC (remote procedure call). The remote procedure call (RPC) is a procedure for activating a subroutine in a remote CPU (central processing unit) by TCP/IP (transmission control protocol/internet protocol). In the RPC, a group of functions providing network services are prepared in the server side, and the function in such group can be called from a client process in another terminal of the network, like the function in a local device. The flow of the interprocess communication in the RPC is as follows.

As a service request to the server, the client calls an RPC function prepared in the server. At this point, a data packet containing call information for the function is sent to the server, whereby the program of the client is interrupted. Upon receiving the packet, the server dispatches the called function. The dispatch means that the server returns the result of operation to the client, or, in this case, that the operating system of the server executes control such as operation assignment etc. After an argument of the function is extracted, the service is executed according to such argument, and the result of such service is returned to the client. After receiving the result of function, the client restarts the execution of the program. The relation of the client and the server in RPC can be realized in two types: connection type and connectionless type.

### SUMMARY OF THE INVENTION

However, the above-described conventional configuration has been associated with a drawback of slow data transmission, because the server application and the client application of the network management software generally establish a relation of connection type for data exchange and then execute data communication of the connection type, utilizing the established relation.

In consideration of the foregoing, the server and the client of the network management software switch the data transmission methods of connection type and connectionless type according to the size of the data to be transmitted, thereby selectively utilizing a pack of datagram type and that of data stream type, and enabling high-speed data communication.

Also the conventional configuration has been associated with a drawback that, if the server application of the network management software commits a failure in the data transmission to the client application, the client application cannot know the failure in the transmission from the server application so that the function of the client application is terminated.

In consideration of the foregoing, in the present invention, the communication between the server and the client of the network management software is managed by a timer and a timer out value, and, in case of a failure in the data transmission from the server to the client, the client is rendered possible to execute an error process or the like within the client, based on the timer management.

### BRIEF DESCRIPTION OF THE DRAWINGS

FIG. 1 is a block diagram showing an example of the configuration of a network management apparatus in a network system embodying the present invention;

FIG. 2 is a schematic view showing an example of the configuration of a network system embodying the present invention;

FIG. 3 is a view showing the relationship between NetSot GUI and VDC in a network system embodying the present invention;

FIG. 4 is a view showing an example of display of a device list in an embodiment of the present invention;

FIG. 5 is a view showing an example of display of a device details list in an embodiment of the present invention;

FIG. 6 is a view showing an example of display of File VDC in an embodiment of the present invention;

FIG. 7 is a flow chart showing the process of a request operation in an embodiment of the present invention;

FIG. 8 is a flow chart showing the process of a callback operation in an embodiment of the present invention;

FIG. 9 is a view showing an example of configuration of memory content of a storage medium storing a program and related data of the present invention;

FIG. 10 is a schematic view showing an example supply of the program and related data of the present invention from the storage medium to the apparatus;

FIG. 11 is a flow chart showing an operation in a synchronized function, in the NetGUI in an embodiment of the present invention;

FIG. 12 is a flow chart showing an operation in a non-synchronized function, in the NetGUI in an embodiment of the present invention; and

FIG. 13 is a flow chart showing the method of calculation of a time out value in case of acquiring information of a device in an embodiment of the present invention.

### DESCRIPTION OF THE PREFERRED EMBODIMENTS

Now the present invention will be clarified in detail by embodiments thereof, with reference to accompanying drawings.

The network management system embodying the present invention is composed of a server apparatus (server application) and a client apparatus (client application). The server apparatus utilizes the packet of connectionless type in the communication with the device on the network, relying on the SNMP/MIB, thereby acquiring data from the device on the network or change of such data. In the interprocess communication between the server application and the client application, the communication of connection type and that of connectionless type are dynamically switched thereby avoiding slow transmission and reception of data.

In the conventional technology, the server application and the client application establish a relation of connection type and execute the data communication of connection type utilizing thus established connection, so that the data transmission and reception become slow. In the following there will be given a more detailed explanation on the technology of the present invention.

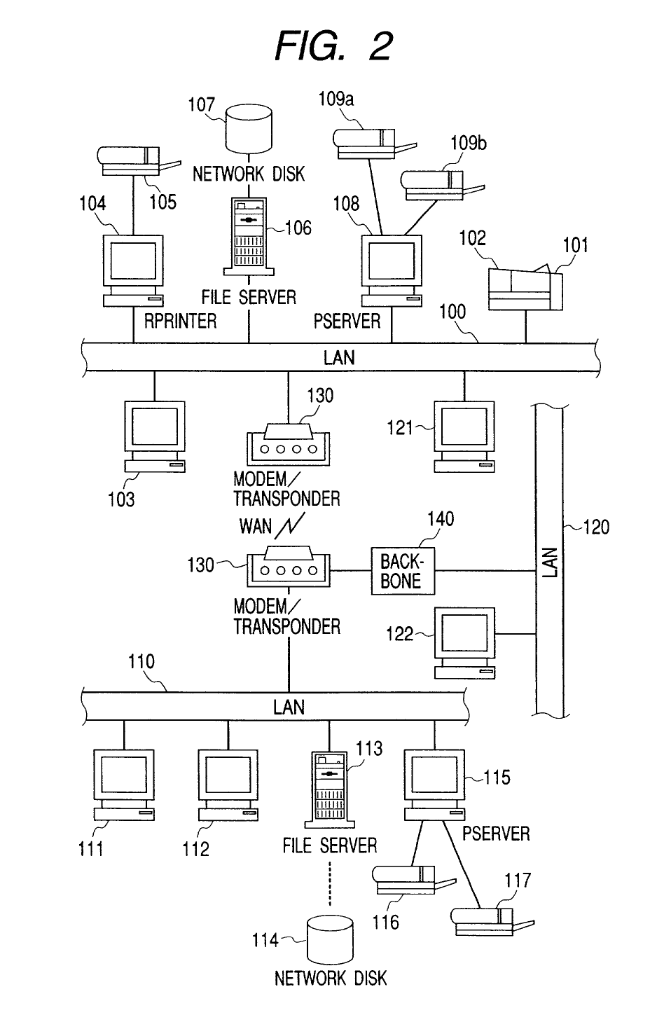

FIG. 2 is a schematic view showing an example of the configuration of a network system embodying the present invention. In the network system embodying the present invention, a LAN (local area network) 100 is connected to a printer 102 provided with a network board (NB) 101 and having an open architecture,a personal computer (PC) 103, a personal computer (PC) 104, a file server 106, a print server 108, a personal computer (PC) 121 and a modulator/demodulator (MODEM) /transponder 130.

On a LAN 110, there are connected a personal computer (PC) 111, a personal computer (PC) 112, a file server 113, a print server 115, and a modulator/demodulator (MODEM)/transponder 130.

On a LAN 120, there are connected a personal computer (PC) 122 and a backbone 140. Also a printer 105 is connected to the personal computer (PC) 104.

Also printers 109a, 109b are connected to the print server 108, while printers 116, 117 are connected to the print server 115, and a modulator/demodulator (MODEM)/transponder 130 is connected to the backbone 140.

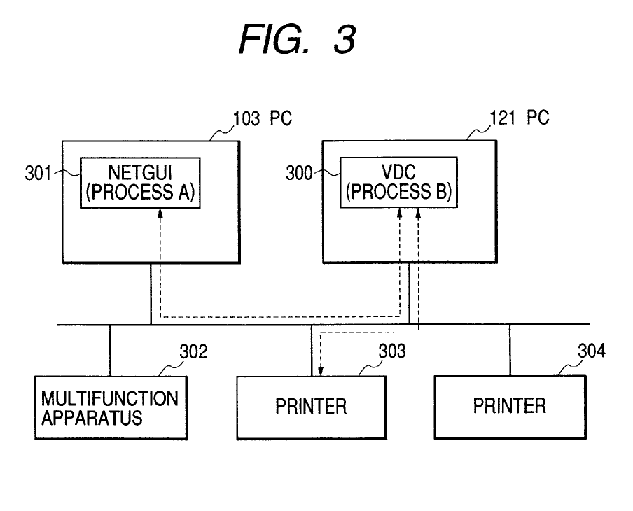

Thus, in the above-described configuration, on the LAN 100, the printer 102 is connected thereto through the network board (NB) 101 and has an open architecture. The personal computer (PC) 103 is used for various information processings and has a configuration shown in FIG. 3. The personal computer (PC) 104 is used for various information processings. The file server 106 executes file management for the user in a network disk 107. The print server 108 is connected to the printers 109a, 109b and executes print service by such printers for other PC's on the LAN 100. The personal computer (PC) 121 is used for various information processings and has a configuration shown in FIG. 3. The modulator/demodulator (MODEM)/transponder 130 has a relaying function among the LAN's 100, 110 and 120.

On the LAN 110, the personal computers (PC) 111, 112 are used for various information processings. The file server 113 executes file management for the user in a network disk 114. The print server 115 is connected with the printers 116, 117 and executes print service by such printers for other PC's on the LAN 110. The modulator/demodulator (MODEM)/transponder 130 has a relaying function among the LAN's 100, 110 and 120.

On the LAN 120, the personal computers (PC) 122 is used for various information processings. The backbone 140 is a communication medium connecting the LAN's 100, 110 and 120, performing a basic role of transmitting the communication through the LAN's 100, 110 and 120, and is connected to the modulator/demodulator (MODEM)/transponder 130 on the LAN 110. The modulator/demodulator (MODEM)/transponder 130 on the LAN 110 and that on the LAN 100 are so designed as to be capable of communication through a WAN (wide area network).

In the foregoing configuration, printers are connected to the network, but, if other peripherals such as a copying machine, a multi function device, a scanner etc. are connected to the network, such peripherals become the object of management by the network management software.

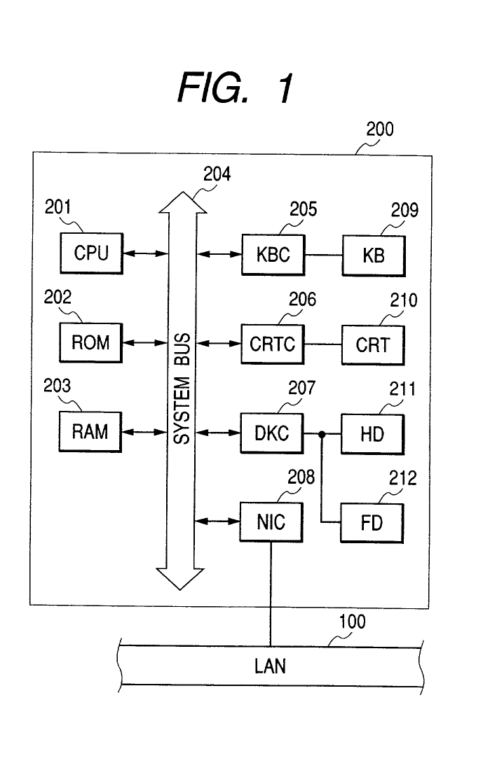

FIG. 1 is a block diagram showing an example of the configuration of the network management apparatus (PC 103 or 121 on which the network management software functions) in the network system shown in FIG. 2. In addition to the PC 103 or 122, the network management apparatus may also be constituted by another PC on which the network management software functions.

The network management apparatus 200 is provided with a CPU (data conversion means, connection management means) 201, a ROM 202, a RAM 203, a system bus 204, a keyboard controller (KBC) 205, a CRT controller (CRTC) 206, a disk controller (DKC) 207, a network interface card (NIC) 208 (communication means), a keyboard (KB) 209, a CRT (display means) 210, a hard disk (HD) 211, and a floppy disk (FD) 212. Each of the PC's 103, 121 shown in FIG. 2 is provided with the configuration shown in FIG. 1, wherein 100 indicates a LAN.

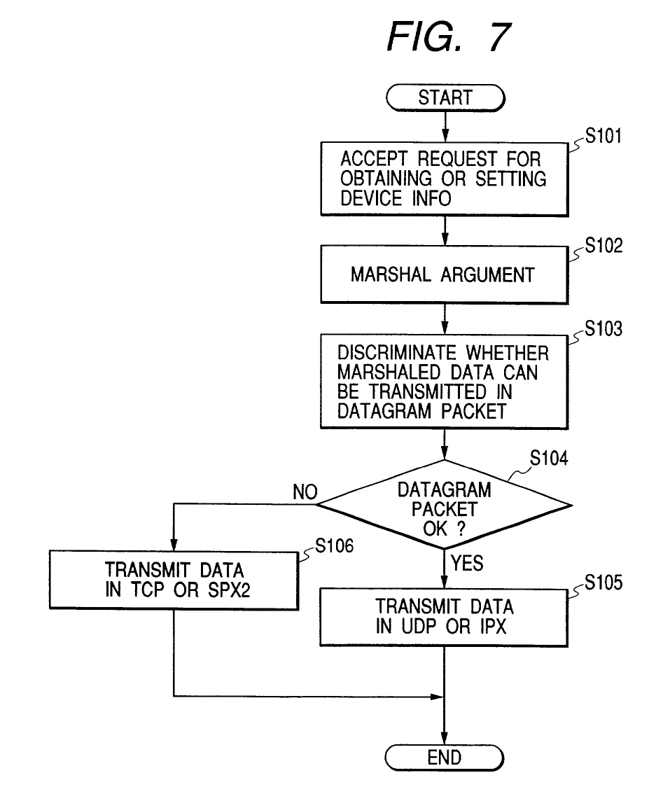

In the above-described configuration, the CPU 201 is a central processing unit controlling the entire apparatus through the system but 204 and executing a process represented by a flow chart shown in FIG. 7, 8, 11, 12 or 13 to be explained later. The data conversion means and the connection management means are realized by the CPU 201 and the network management program executed by the CPU 201.

The ROM is used for storing programs and fixed data. The RAM 203 is used for storing various data. The keyboard controller (KBC) 205 controls the data input from the keyboard (KB) 209. The CRT controller (CRTC) 206 controls the display on the CRT 210. The disk controller (DKC) 207 controls data writing into and reading from the hard disk (HD) 211 and the floppy disk (FD) 212.

The network interface card (NIC) 208 executes interfacing of data communication with the LAN 100. The keyboard (KB) 209 is used for various data inputs and various settings. The CRT 210 constitutes display means for displaying characters and patterns under the control of the CRT controller 206. The display means is not limited to a CRT but may also be composed for example of a liquid crystal display. The hard disk (HD) 211 is used for storing programs to be explained later. The floppy disk (FD) 212 is used for storing various data.

Thus, the network management apparatus of the present invention can be realized on a PC which is similar in configuration to the PC capable of realizing the conventional network management apparatus. The above-described hard disk (HD) 211 stores the network management program of the present invention, constituting the principal part of all the functions to be explained in the following. In all the following description, the principal part of all the execution on the hardware is constituted by the CPU 201 and of the control on the software is constituted by the network management software (network management program) stored in the hard disk (HD) 211, unless stated otherwise. The OS (operating system) in the present embodiment of the present invention is assumed for example as the Windows 95 (Microsoft), but such example is not restrictive.

Also, the network management program embodying the present invention may be supplied in a form stored in a storage medium such as a floppy disk or a CD-ROM. In such case, the programs are read from the storage medium by the disk controller (DKC) 207 shown in FIG. 1 or by an represented CD-ROM drive, and are installed in the hard disk (HD) 211.

FIG. 3 is a block diagram showing the relationship, in the network system embodying the present invention as shown in FIG. 2, between NetGUI (process constituting a portion of the graphic user interface in the network management software) and VDC (process constituting a communicating portion in the network management software). In the example shown in FIG. 3, the NetGUI (process A) is realized on the PC 103, while the VDC (process B) is realized on the PC 121. Also the NetGUI corresponds to the client application of the network management software, and the VDC corresponds to the server application thereof.

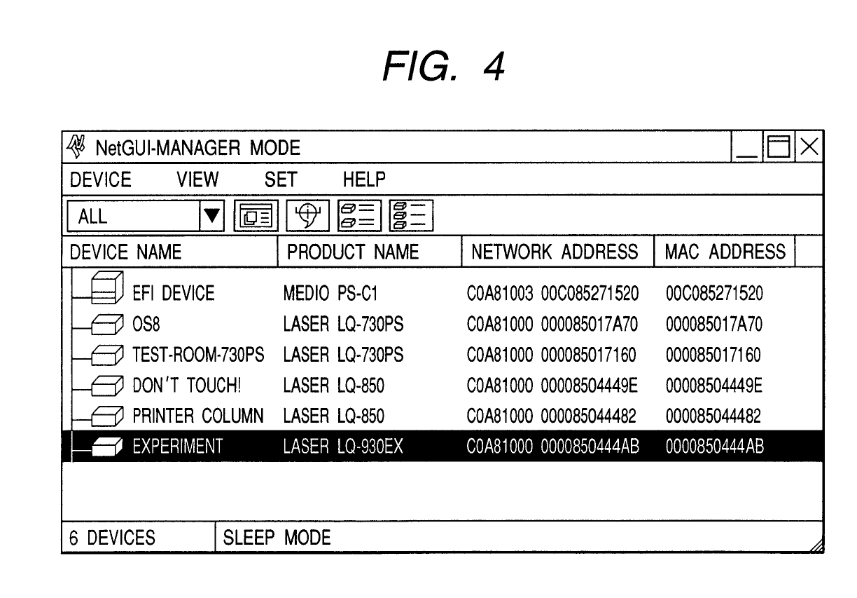

FIG. 4 is a schematic view showing an example of display of a device list, in which each device is displayed in correlation with a device name, a product name, a network address etc. The NetGUI acquires device information for each device from the VDC and generates, based on such information, an image displaying the device name, product name, network address etc.

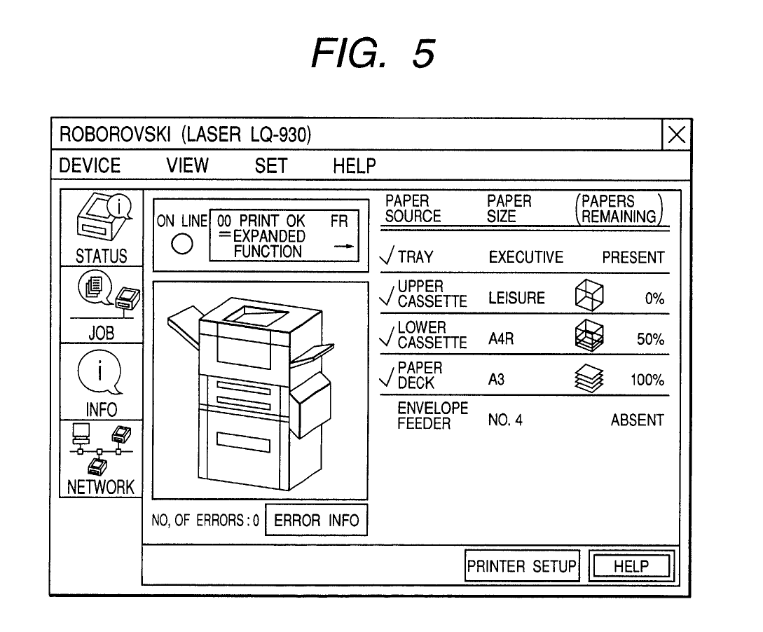

FIG. 5 is a schematic view showing an example of display of a device details window, in which displayed are information for example on the sheet size loaded in each of a tray, an upper cassette, a lower cassette, a paper deck and an envelop feeder provided in the device (printer). When any of the devices displayed on the image shown in FIG. 4 is selected by the user, the detailed information of the selected device is displayed on an image shown in FIG. 5. When a device is selected on the image shown in FIG. 4, the NetGUI acquires the device information on the selected device from the VDC and, based on such device information, generates the information on the sheet size of such device, on the message displayed on a panel of such device and on the error generated in such device.

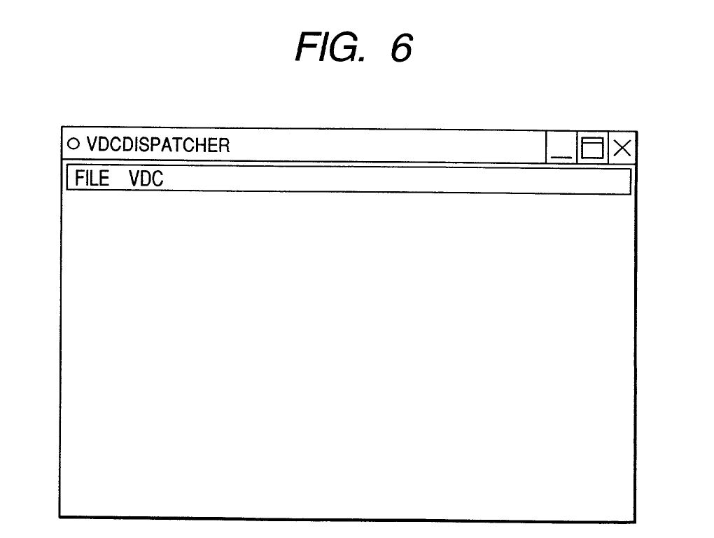

FIG. 6 is a schematic view showing an example of display of the VDC, in which displayed are characters “File VDC”. The images shown in FIGS. 4 to 6 are displayed on the CRT 210 shown in FIG. 1.

FIG. 10 is a schematic view showing the concept of supply of the program of the present invention (network management program) and related data from a storage medium to the apparatus. The program of the present invention and the related data are supplied by inserting a storage medium 1001 such as a floppy disk or a CD-ROM into a drive slot 1003 provided in an apparatus 1002. The execution of the program of the present invention and the related is rendered possible by installing such program and data from the storage medium 1001 into a hard disk and loading them from the hard disk into a RAM, or by directly loading them into the RAM without installing in the hard disk.

In such case, in the network management apparatus embodying the present invention, the execution of the program of the present invention is rendered possible by supplying the network management apparatus with the program of the present invention and the related data in a procedure as shown in FIG. 10, or by storing the program of the present invention and the related data in advance in the network management apparatus.

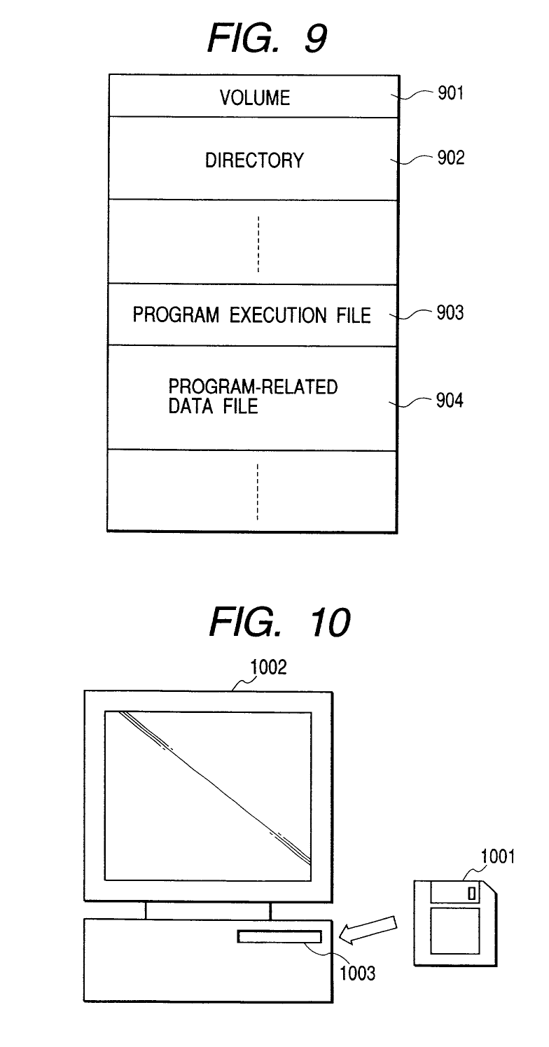

FIG. 9 is a schematic view showing an example of configuration of the content of a storage medium storing the program of the present invention (network management program) and the related data. The storage medium of the present invention stores, for example, volume information 901, directory information 902, a program execution file 903, a program related data file 904 etc. The program of the present invention is formed into program codes based on flow charts shown in FIGS. 7, 8, 11, 12 and 13 to be explained later.

In the following there will be explained, with reference to FIGS. 3, 7, 8, 11, 12 and 13, the function of the network management apparatus embodying the present invention and having the above-described configuration. In the following description, the process constituting a portion of the GUI in the network management software of the present embodiment will be called “NetGUI”, and the process constituting a communicating portion in the network management software will be called “VDC”.

In FIG. 3, the NetGUI process and the VDC process are respectively activated on the PC's 103, 121 shown in FIG. 2, for managing the printer 102 (in which the SNMP agent is loaded). The NetGUI executes communication with the VVDC by the interprocess communication function, and the VDC executes communication with the devices by the SNMP protocol.

In order to acquire information from the device, the NetGUI executes interprocess communication with proxy, and transmits, to the VDC, information indicating the device information to be acquired. The VDC receives the information transmitted from the NetGUI through stab, and acquires MIB information from the device utilizing the SNMP protocol. The acquired information is transmitted, from the stab of the VDC, to the proxy by the interprocess communication, and callback informed from the proxy to the NetGUI. Based on the callback information from the VDC, the NetGUI executes a bit map display thereby indicating the device information on the CRT 210.

Based on the callback information from the VDC, the NetGUI executes a bit map display thereby indicating the device information, of which an example is shown in FIG. 4. The illustrated example shows the presence of 6 devices within the range of management, and displays the product name, network address and MAC address of each device. In the lowermost row, there is displayed that the device status is in a sleep mode.

For setting information in the device, the NetGUI executes interprocess communication utilizing proxy, thereby transmitting information, indicating the device information to be set, to the VDC. The VDC receives the information transmitted from the NetGUI through stab, and sets MIB information in the device utilizing the SNMP protocol. The information indicting whether the setting has succeeded or failed is transmitted, from the stab of the VDC, to the proxy by the interprocess communication, and callback informed from the proxy to the NetGUI. Based on the callback informed from the VDC, the NetGUI executes a bit map display thereby indicating the device information on the CRT 210.

Based on the callback information from the VDC, the NetGUI executes a bit map display thereby indicating the set information, of which an example is shown in FIG. 5. The illustrated example shows a status sheet of a printer constituting a device. FIG. 5 shows a device details window for controlling or managing the peripheral devices of the network, which is one of the windows displayed by the NetGUI in succession according to the instruction of the user, when the user activates NetSpot in a manager mode. FIG. 5 shows the status of LASER LQ-930, which is the device displayed in FIG. 4 (in the lowermost row). In this window, the user can select “job sheet”, “information sheet” or “network sheet”, and each sheet is displayed according to the selection. In FIG. 5, there is also provided an error display area under the graphics of printer. Even in the absence of instruction from the user, the NetGUI automatically renews various windows according to the operation status of the NetSpot and the information acquired from the network.

At first there will be explained, with reference to a flow chart shown in FIG. 7, request process from the proxy of the NetGUI, namely a process of requesting the device information from the NetGUI to the VDC. The flow chart in FIG. 7 shows a case of information acquisition/setting, and also shows a case where the protocol between the client apparatus and the server apparatus employs TCP/IP (transmission control protocol/internet protocol) and NetWare (network operating system developed by Novel Inc., U.S.A.).

However the protocol is not limited to such TCP/IP and NetWare, but the protocols of datagram type and data stream type can be suitably adopted. A step S101 receives a request for the acquisition or setting of the device information. A step S102 executes marshaling of the argument data of API (application program interface) called for the request. An RFC function is called by the calling of the API, and the argument data thereof constitute those of the RFC function.

A step S103 discriminates whether the size of thus marshaled data can be transmitted by a packet of datagram type, and, if a step S104 identifies that the transmission by a packet of datagram type is possible, the sequence proceeds to a step S105 for executing a packet transmission of datagram type. For example, in case of using the TCP/IP protocol, there is used UDP (user datagram protocol, which is one of four layers of TTCP/IP). Also in case of using the NetWare, there is used IPX. If the size of the aforementioned marshaled data cannot be accommodated in a packet of datagram type, the sequence proceeds to a step S106 for executing transmission with a packet of data stream type. For example, in case of using the TCP/IP protocol, there is used TCP. Also in case of using the NetWare, there is used IPX2.

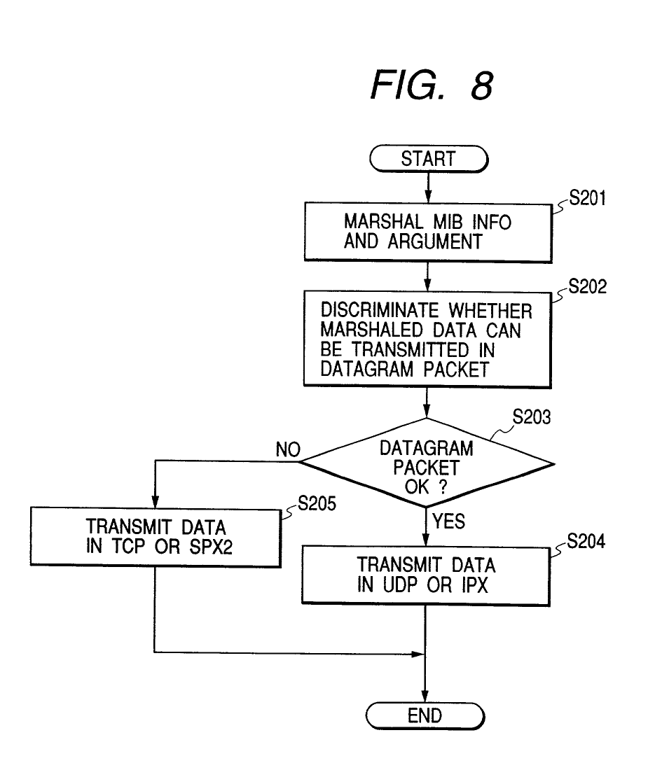

In the following there will be explained, with reference to a flow chart shown in FIG. 8, a callback process from the step of the VDC, namely a process of transmission of the device information from the VDC to the NetGUI.

A step S201 executes marshaling of data (MIB information) acquired from the device and the argument data of a callback function. A step S202 discriminates whether the size of thus marshaled data can be transmitted by a packet of datagram type.

The VDC acquires MIB information from the device, according to the request from the NetGUI. Particularly in case the NetGUI requests information on the device selected by the user, the VDC receives a device ID, indicating the device selected by the user, from the NetGUI, and acquires the MIB information from the device indicated by the device ID.

If a step S203 identifies that the size of the marshaled data can be transmitted by a packet of datagram type, the sequence proceeds to a step S204 for executing a packet transmission of datagram type. For example, in case of using the TCP/IP protocol, there is used UDP. Also in case of using the NetWare, there is used IPX (internetwork packet exchange, which is a network protocol of NetWare 386 developed by Novel Corp.).

If the size of the aforementioned marshaled data cannot be accommodated in a packet of datagram type, the sequence proceeds to a step S205 for executing transmission with a packet of data stream type. For example, in case of using the TCP/IP protocol, there is used TCP. Also in case of using the NetWare protocol, there is used SPX2.

As explained in the foregoing, the network management apparatus embodying the present invention executes a network management program for executing transmission of the connectionless type or connection type respectively if the size of the transmitted data is small or large.

Owing to the control managing the transmissions of connection type and connectionless type, in the data transmission between the server application and the client application, it is rendered possible to achieve high-speed data transmission by employing transmission of connectionless type or that of connection type respectively if the size of the data to be transmitted is small or large.

Also owing to the control switching the transmission of connection type and connectionless type according to the size of the transmitted data, it is rendered possible to achieve high-speed data transmission by executing transmission of connectionless type or that of connection type respectively if the size of the data to be transmitted is small or large.

More specifically, in the embodiment of the present invention, in case the communication speed is low because the data transmission is executed by establishing the relation of connection type between the server application and the client application, the high-speed data communication can be achieved by switching the data transmission of connection type and connectionless type according to the size of the transmitted data, thereby selectively employing the packet of datagram type and that of data stream type.

In the following there will be explained a timer management.

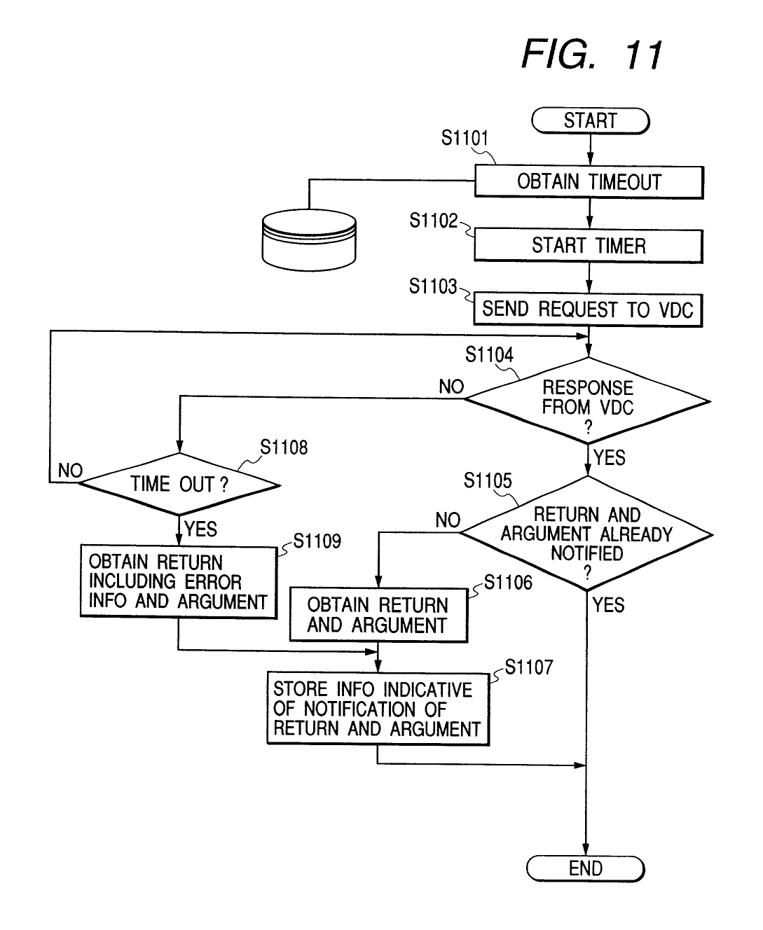

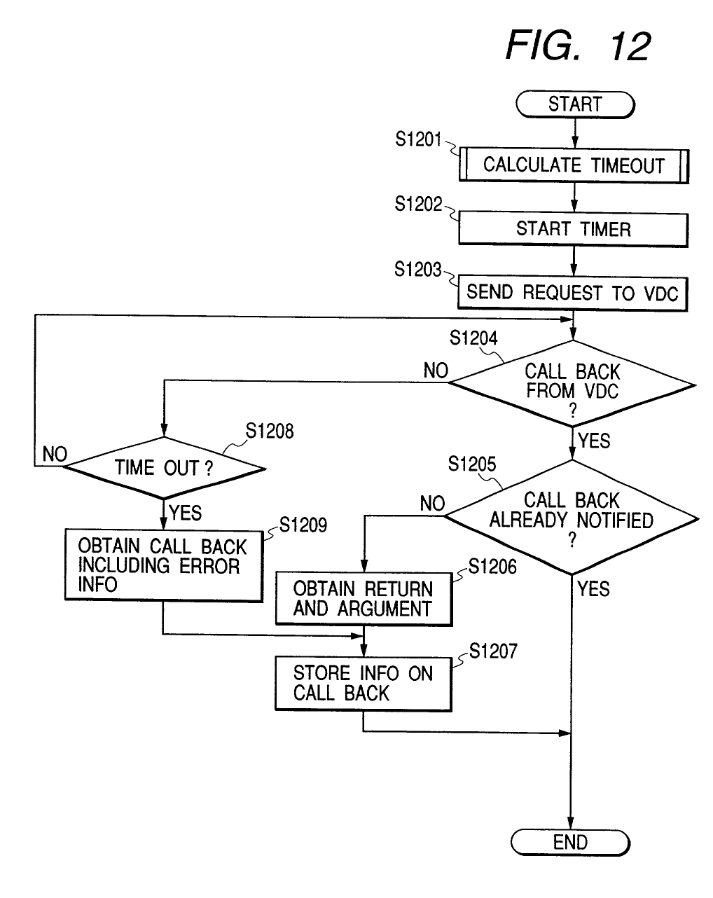

FIG. 11 is a flow chart showing the process of the NetGUI in case the RFC function is a synchronized function, and FIG. 12 is a flow chart showing the process of the NetGUI in case the RFC function is an unsynchronized function.

Referring to FIG. 11, a step S1101 acquires an appropriate time-out value (hereinafter represented as TIMEOUT) according to the characteristics of the called API (or read RFC function). The TIMEOUT is registered in a database for each API of each module.

A step S1102 starts a timer utilizing the time-out value obtained in the step S1101, in order to monitor the time required for processing of the synchronized function in the VDC (stab) and returning of the marshaled data to the proxy of the NetGUI.

In a step S1103, the NetGUI executes a request by the synchronized function to the proxy. The proxy executes marshaling of the request data and transmits such data to the VDC constituting another process. After the transmission of the marshaled data, the proxy temporarily stops the API-called sled until the data are returned from the VDC (stab), in order to provide the NetGUI with the synchronized function.

A step S1104 confirms whether a response has been received from the VDC, and, if received, a step S1105 confirms whether a return value (hereinafter represented as RETURN) and an argument of the synchronized function have been informed from the proxy to the NetGUI. If the RETURN and the argument of the synchronized function have already been received, the information received from the VDC is disregarded and the sequence is terminated.

If the RETURN and the argument of the synchronized function have not been informed to the NetGUI, the sequence proceeds to a step S1106 for unmarshaling (developing) the data received from the VDC, thereby acquiring the proper RETURN and the argument. Then a step S1107 memorizes that the RETURN and the argument of the synchronized function are informed to the NetGUI.

In case the step S1104 identifies that the response has not been received from the VDC, the sequence proceeds to a step S1108 for confirming whether the timer started in the step S1102 has already expired. If not, the sequence returns to the step S1104 for awaiting the reception of response from the VDC. If the timer has already expired, the sequence proceeds to a step S1109 for acquiring the RETURN and the argument, including error information. Then a step S1107 memorizes that the RETURN and the argument of the synchronized function are informed to the NetSpotGUI. The proceeding of the sequence from S1109 to S1107 allows, if a response is received from the VDC after the expiration of the time, to disregard such RETURN and argument, and allows to avoid that the belated response hinders the function of the NetGUI.

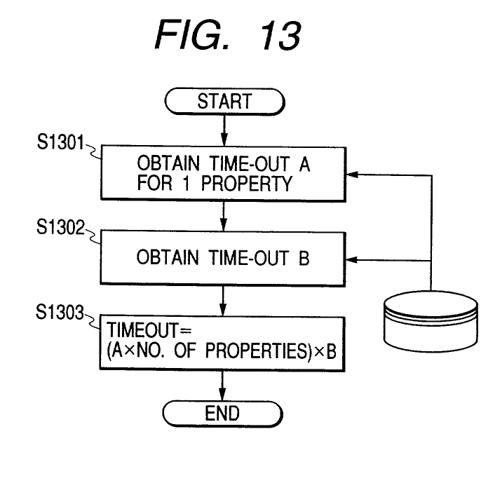

In the following there will be explained, with reference to a flow chart in FIG. 12, a callback call of an unsynchronized function. A step S1201 calculates an appropriate TIMEOUT according to the called API. The calculation method of the TIMEOUT will be explained later with reference to a flow chart shown in FIG. 13.

A step S1202 starts a timer utilizing the TIMEOUT value calculated in the step S1201, in order to monitor the time of accepting a callback of the unsynchronized function from the VDC. Then, in a step S1203, the NetGUI executes a request by the unsynchronized function to the proxy. The proxy executes marshaling of the request data and transmits such data to the VDC constituting another process.

A step S1204 confirms whether a callback to the unsynchronized function has been received from the VDC. If received, a step S1205 confirms whether the callback have been informed to the NetGUI. If the callback has already been informed to the NetGUI, the information received from the VDC is disregarded and the sequence is terminated. If the callback has not been informed to the NetGUI, the sequence proceeds to a step S1206 for unmarshaling the data received from the VDC, thereby acquiring the proper RETURN and argument. Then a step S1207 memorizes that the callback has been made to the NetGUI.

In case the step S1204 identifies that the callback has not been received from the VDC, the sequence proceeds to a step S1208 for confirming whether the timer started in the step S1202 has already expired. If not, the sequence returns to the step S1204 for awaiting the callback. If the timer has already expired, the sequence proceeds to a step S1209 for acquiring the callback including error information. Then the sequence proceeds to a step S1207 for memorizing that the callback has been made to the NetGUI. The proceeding of the sequence from S1209 to S1207 allows, if a response is received from the VDC after the expiration of the time, to disregard the RETURN and argument thereof, and allows to avoid that the belated response hinders the function of the NetGUI.

Now reference is made to a flow chart in FIG. 13 for explaining the method of calculating the TIMEOUT if the NetGUI acquires the device information from the VDC. For acquiring the device information, there is acquired a property indicating attribute data, representing the function status of the device and various settings thereof. The acquisition of information from the device is rendered possible by requesting a group of such properties to the VDC.

A step S1301 acquires, from a database, a time-out value A indicating the waiting time for the acquisition of a property. Then a MOS transistor 1302 acquires, from the database, a time-out value B depending on the function characteristics of the VDC. For example, in the acquisition of device information, there is provided a system of repeating the transmission 3 times at an interval of 3 seconds in case of the failure in the acquisition of device information, and the database stores a time-out value B determined in consideration of such system.

A step S1303 calculates the actual waiting time for the callback reception from the VDC, utilizing thus acquired time-out values A and B. For acquiring the device information, there is adopted a calculation formula of (time-out value A×number of properties)×time-out value B.

As explained in the foregoing, the network management apparatus of the present invention allows, by the timer process executed in the client application in case the server application of the network management software fails to transmit the data to the client application, to prevent the interruption of the operation of the client application and to prevent that the operation of the client application is hindered by the transmission of the information, belatedly informed after the expiration of the timer, to the client application.

(1) In the foregoing embodiments of the present invention, there has been explained a network system shown in FIG. 2, but the present invention is not restricted by such example and the number of the PC, print server, file server, printer, modulator/demodulator/transponder etc. and the number of LAN's may be modified arbitrarily.

(2) In the foregoing embodiments of the present invention, there has been explained the electrophotographic printer (laser beam printer) as an example of the device list shown in FIG. 4, but the present invention is not restricted by such example and is also applicable to the printer of other types such as ink jet type, electrostatic type, charge destruction type, thermal transfer type or thermosensitive type, in addition to the printer of electrophotographic type.

(3) Also in the foregoing embodiments of the present invention, there has been explained a printer as the device connected to the network, but the present invention is not restricted by such example and it is also possible to connect other devices such as a scanner or a copying machine to the network, instead of the printer.

(4) Also in the foregoing embodiments of the present invention, there has been explained a case of realizing the NetGUI by the PC 103 on the LAN 100 and the VDC by the PC 121 on the LAN 100, but the present invention is not restricted by such example and is also applicable to a case where the NetGUI and the VDC by other PC's on the LAN 100 or PC's on the LAN 110 or PC's on the LAN 120.

The present invention may be applied to a system consisting of plural equipment or an apparatus consisting of a single equipment. Also the present invention includes a case where a memory medium storing the program codes of a software realizing the function of the aforementioned embodiments is supplied to a system or an apparatus and the computer (CPU or MPU) of the above-mentioned system or apparatus reads and executes the program codes stored in the memory medium.

In such case the program codes themselves read from the storage medium realize the function of the aforementioned embodiments, and the program codes themselves constitute the present invention. The memory medium storing such program codes can be, for example, a floppy disk, a hard disk, an optical disk, a magnetooptical disk, a CD-ROM, a CD-R, a magnetic tape, a non-volatile memory card or a ROM.

The present invention also includes not only a case where the functions of the aforementioned embodiments are realized by the execution of the read program codes by the computer but also a case where an operating system or the like functioning on the computer executes all or a part of the actual processes under the control of such program codes thereby realizing the functions of the aforementioned embodiments.

The present invention further includes a case wherein the program codes read from the memory medium are once stored in a memory provided in a function expansion board inserted into the computer or a function expansion unit connected to the computer, and a CPU provided in the function expansion board or the function expansion unit executes all the process or a part thereof according to the instructions of such program codes, thereby realizing the functions of the aforementioned embodiments.

As explained in the foregoing, the present invention executes control for communication of connection type and that of connectionless type. Therefore, in the data transmission between the server application and the client application in the network management system, there can be achieved high-speed data transmission by employing transmission of connectionless type or that of connection type respectively if the size of the transmitted data is small or large.

More specifically, in case the communication speed is low because the data transmission is executed by establishing the relation of connection type between the server application and the client application, the high-speed data communication can be achieved by switching the data transmission of connection type and connectionless type according to the size of the transmitted data, thereby selectively employing the packet of datagram type and that of data stream type.

Also according to the present invention, owing to the switching of the transmission method of connection type and that of connectionless type according to the size of the transmitted data, the data transmission can be achieved at a high speed by executing transmission of connectionless type and that of connection type respectively if the size of the transmitted data is small or large.

More specifically, in case the communication speed is low because the data transmission is executed by establishing the relation of connection type between the server application and the client application, the high-speed data communication can be achieved by switching the data transmission of connection type and connectionless type according to the size of the transmitted data, thereby selectively employing the packet of datagram type and that of data stream type.

As explained in the foregoing, the network device control apparatus and method and the network management apparatus of the present invention allow, by the timer process executed in the GUI client application in case the communication server application of the network management software fails to transmit the data to the GUI client application, to prevent the interruption of the operation of the GUI client application and to prevent that the operation of the client application is hindered by the transmission of the information, belatedly informed after the expiration of the timer and belatedly deleted in the proxy, to the GUI client application.

What is claimed is:

1. An information processing apparatus for transmitting data to an external apparatus for communication of information on a device, comprising:
calculation means for calculating the size of data to be transmitted; and
connection control means for judging, according to the data size calculated by said calculation means, whether the communication to said external apparatus is executed by connection type or connectionless type.

2. An information processing apparatus according to claim 1, wherein said connection control means switches the communication of connection type and that of connectionless type based on the result of judgment.

3. An information processing apparatus according to claim 1, wherein the communication with said external apparatus is judged to be executed by connectionless type or connection type respectively when the data size calculated by said calculation means is smaller or larger than a predetermined size.

4. An information processing apparatus according to claim 1, wherein the communication with said external apparatus is judged to be executed by connectionless type or connection type respectively when the data size calculated by said calculation means can be transmitted or not by a packet of datagram type.

5. An information processing apparatus according to claim 1, further comprising:
acquisition means for acquiring, from a device connected through a network, information on said device;
wherein the device information acquired by said acquisition means is transmitted to said external apparatus.

6. An information processing apparatus according to claim 2, wherein said acquisition means acquire MIB information on the device, utilizing SNMP.

7. An information processing apparatus according to claim 1, wherein said acquisition means acquires information on a device selected by the user at said external apparatus;
and the information on the device selected by the user, acquired by said acquisition means, is transmitted to said external apparatus.

8. An information processing apparatus according to claim 1, further comprising display control means for causing a display unit to display the information on the device, received from said external apparatus.

9. An information processing apparatus according to claim 8, wherein:
the transmitted data are for requesting information on plural devices connected to a network; and
said display control means causes the display unit to display information on each of the plural devices.

10. An information processing apparatus according to claim 8, wherein:
the transmitted data are for requesting information on a device selected by the user among the plural devices; and
said display control means causes, according to the selection of the user, the display unit to display information on the device selected by the user.

11. An information processing apparatus according to claim 8, further comprising:
timer management means for starting a timer in response to the request of information on the device to said external apparatus; and
informing means for internally informing error information in case said timer management means shows a time-out state.

12. An information processing apparatus according to claim 11, wherein said time-out state is based on the characteristics of a function called at the request of the information on said device to said external apparatus.

13. An information processing apparatus according to claim 11, wherein the information from said external apparatus is disregarded after said timer management means shows a time-out state.

14. A network management system for data communication between a server and a client for communication of information on a device, comprising:
calculation means for calculating the size of data to be transmitted; and
connection control means for judging, according to the data size calculated by said calculation means, whether said server and said client executes the communication of said data by connection type or connectionless type with an external apparatus.

15. A network management system according to claim 14, wherein the communication with said external apparatus is judged to be executed by connectionless type or connection type respectively when the data size calculated by said calculation means is smaller or larger than a predetermined size.

16. A network management system according to claim 14, wherein the communication with said external apparatus is judged to be executed by connectionless type or connection type respectively when the data size calculated by said calculation means can be transmitted or not by a packet of datagram type.

17. A network management system according to claim 14, further comprising:
acquisition means for acquiring, from a device connected through a network, information on said device;
wherein the device information acquired by said acquisition means is transmitted from said server to said client.

18. A network management system according to claim 14, wherein said client includes display control means for causing a display unit to display the information on the device, received from said external apparatus.

19. An information processing method to be executed by an information processing apparatus for transmitting data to an external apparatus for communication of information on a device, the method comprising:
a calculation step of calculating the size of data to be transmitted; and
a connection control step of judging, according to the data size calculated by said calculation step, whether the communication to said external apparatus is executed by connection type or connectionless type.

20. An information processing method according to claim 19, wherein said connection control step switches the communication of connection type and that of connectionless type based on the result of judgment.

21. An information processing method according to claim 19, wherein the communication with said external apparatus is judged to be executed by connectionless type or connection type respectively when the data size calculated by said calculation step is smaller or larger than a predetermined size.

22. An information processing method according to claim 19, wherein the communication with said external apparatus is judged to be executed by connectionless type or connection type respectively when the data size calculated by said calculation step can be transmitted or not by a packet of datagram type.

23. An information processing method according to claim 19, further comprising:
an acquisition step of acquiring, from a device connected through a network, information on said device;
wherein the device information acquired by said acquisition step is transmitted to said external apparatus.

24. An information processing method according to claim 20, wherein said acquisition step acquires MIB information on the device, utilizing SNMP.

25. An information processing method according to claim 19, wherein said acquisition step acquires information on a device selected by the user at said external apparatus; and
the information on the device selected by the user, acquired by said acquisition step, is transmitted to said external apparatus.

26. An information processing method according to claim 19, further comprising a display control step of causing a display unit to display the information on the device, received from said external apparatus.

27. An information processing method according to claim 26, wherein:
the transmitted data are for requesting information on plural devices connected to a network; and
said display control step causes the display unit to display information on each of the plural device.

28. An information processing method according to claim 26, wherein:
the transmitted data are for requesting information on a device selected by the user among the plural devices; and
said display control step causes, according to the selection of the user, the display unit to display information on the device selected by the user.

29. An information processing method according to claim 26, further comprising:
a timer management step of starting a timer in response to the request of information on the device to said external apparatus; and
an informing step of internally informing error information in case said timer management step shows a time-out state.

30. An information processing method according to claim 29, wherein said time-out state is based on the characteristics of a function called at the request of the information on said device to said external apparatus.

31. An information processing method according to claim 29, wherein the information from said external apparatus is disregarded after said timer management step shows a time-out state.

32. An information processing program to be executed by an information processing apparatus for transmitting data to an external apparatus for communication of information on a device, the program comprising, for execution by a computer;
a calculation step of calculating the size of data to be transmitted; and
a connection control step of judging, according to the data size calculated by said calculation step, whether the communication to said external apparatus is executed by connection type or connectionless type.

33. An information processing program according to claim 32, wherein said connection control step switches the communication of connection type and that of connectionless type based on the result of judgment.

34. An information processing program according to claim 32, wherein the communication with said external apparatus is judged to be executed by connectionless type or connection type respectively when the data size calculated by said calculation step is smaller or larger than a predetermined size.

35. An information processing program according to claim 32, wherein the communication with said external apparatus is judged to be executed by connectionless type or connection type respectively when the data size calculated by said calculation step can be transmitted or not by a packet of datagram type.

36. An information processing program according to claim 32, wherein said program further comprising an acquisition step of acquiring, from a device connected through a network, information on said device for execution by a computer; and
the device information acquired by said acquisition step is transmitted to said external apparatus.

37. An information processing program according to claim 33, wherein said acquisition step acquires MIB information on the device, utilizing SNMP.

38. An information processing program according to claim 32, wherein said acquisition step acquires information on a device selected by the user at said external apparatus; and
the information on the device selected by the user, acquired by said acquisition step, is transmitted to said external apparatus.

39. An information processing program according to claim 32, further comprising, for execution by a computer, a display control step of causing a display unit to display the information on the device, received from said external apparatus.

40. An information processing program according to claim 39, wherein:
the transmitted data are for requesting information on plural devices connected to a network; and
said display control step causes the display unit to display information on each of the plural devices.

41. An information processing program according to claim 39, wherein:
the transmitted data are for requesting information on a device selected by the user among the plural devices; and
said display control step causes, according to the selection of the user, the display unit to display information on the device selected by the user.

42. A memory medium storing an information processing program to be executed by an information processing apparatus for transmitting data to an external apparatus for communication of information on a device, the program comprising:
a calculation step of calculating the size of data to be transmitted; and
a connection control step of judging, according to the data size calculated by said calculation step, whether the communication to said external apparatus is executed by connection type or connectionless type.

43. A memory medium according to claim 42, wherein said connection control step switches the communication of connection type and that of connectionless type based on the result of judgment.

44. A memory medium according to claim 42, wherein the communication with said external apparatus is judged to be executed by connectionless type or connection type respectively when the data size calculated by said calculation step is smaller or larger than a predetermined size.

45. A memory medium according to claim 42, wherein the communication with said external apparatus is judged to be executed by connectionless type or connection type respectively when the data size calculated by said calculation step can be transmitted or not by a packet of datagram type.

46. A memory medium according to claim 42, wherein said program further comprises an acquisition step of acquiring, from a device connected through a network, information on said device for execution by a computer; and
the device information acquired by said acquisition step is transmitted to said external apparatus.

47. A memory medium according to claim 43, wherein said acquisition step acquires MIB information on the device, utilizing SNMP.

48. A memory medium according to claim 42, wherein said acquisition step acquires information on a device selected by the user at said external apparatus; and
the information on the device selected by the user, acquired by said acquisition step, is transmitted to said external apparatus.

49. A memory medium according to claim 42, further comprising, for execution by a computer, a display control step of causing a display unit to display the information on the device, received from said external apparatus.

50. A memory medium according to claim 49, wherein:
the transmitted data are for requesting information on plural devices connected to a network; and
said display control step causes the display unit to display information on each of the plural devices.

51. A memory medium according to claim 49, wherein:
the transmitted data are for requesting information on a device selected by the user among the plural devices; and
said display control step causes, according to the selection of the user, the display unit to display information on the device selected by the user.
